(19) United States
(12) Patent Application Publication
(10) Pub. No.: US 2002/0097776 A1
(43) Pub. Date: Jul. 25, 2002

(54) Method of measurement employing thermal compensation of a thermopile, and device for implementing it

(76) Inventor: Tan Duc Huynh, Neuilly S/Marne (FR)

Correspondence Address: LINIAK, BERENATO, LONGACRE & WHITE, Suite 240, 6550 Rock Spring Drive, Bethesda, MD, 20817, US

(21) Appl. No.: 10/007,665

(22) Filed: Dec. 10, 2001

(30) Foreign Application Priority Data
Dec. 19, 2000 (FR) 0016568

(51) Int. Cl. G01J 5/16

(52) U.S. Cl. 374/132; 374/133

(57) ABSTRACT

The invention relates to a method of thermal compensation of a thermopile arranged in a sensor housing, characterised in that it implements:

a) the generation of a first voltage U₁ which is a function of an object temperature T_{obj} and of a temperature Tₜₕ of the sensor housing (2), and of a second voltage U₂ which is proportional to the temperature Tₜₕ of the sensor housing.

b) the analog/digital conversion of the first voltage U₁ and of the second voltage U₂.

c) the calculation of the object temperature T_{obj} on the basis of the said digitised voltages U₁ and U₂.

### FIELD OF THE INVENTION

The subject of the present invention is a method of measurement employing thermal compensation of a thermopile, as well as a device for implementing it.

### BACKGROUND OF THE INVENTION

The thermal compensation of this type of component is generally carried out with the aid of discrete components in association with several operational amplifiers.

Such analog compensation is possible only in a narrow temperature range (10° C. to 40° C., for example). The presence of several operational amplifiers induces wide tolerances, and hence inaccuracy in the measurement.

### SUMMARY OF THE INVENTION

The basic idea of the invention is at least partly to surmount these constraints, by employing digital compensation.

The invention thus relates to a method of measurement employing thermal compensation of a thermopile assembly arranged in a sensor housing and including a thermopile and a thermistor, characterised in that it employs:

a) the generation of a first thermopile voltage U₁ which is a function of an object temperature T_{obj} to be measured, and of a temperature Tₜₕ of the sensor housing, and of a second thermistor voltage U₂ which is proportional to the temperature Tₜₕ of the sensor housing.

b) the analog/digital conversion of the first voltage U₁ and of the second voltage U₂.

c) the calculation of the object temperature T_{obj} on the basis of the said digitised voltages U₁ and U₂.

The method can be characterised in that T_{obj} is obtained from the following formula:

$${U}_{1} = \frac{{K}_{3}}{{T}_{th}^{3}} {\int }_{λ min}^{λ max} \frac{{C}_{1} {λ}^{- 5}}{exp ( {C}_{2} / λ Tobj ) - 1}$$

with:

K₃: constant

C₁, C₂: constants of Planck's law

: wavelength of the electromagnetic radiation

min, max: bounds of an infrared filter of the sensor.

T_{obj} can be obtained from a table of values having values of T_{obj} corresponding to values of U₁ and U₂, according to a two-dimensional mapping.

According to one preferred embodiment, the method is characterised in that it employs compensation for tolerances in order to determine a corrected value T′_{obj} from T_{obj}, according to the formula:

T′_{obj}=A T_{obj}+B

A and B corresponding to gain-correction and zero-shift-correction terms which are stored in memory upon calibration of the thermopile assembly during manufacture.

The invention also relates to a device for implementing the method defined above, characterised in that it includes:

an electronic circuit having inputs connected to two terminals of the thermopile assembly so as to supply a said first voltage U₁ and a said second voltage U₂ as output.

a microprocessor storing in memory a relationship between the said first and second voltage U₁ and U₂ and the object temperature T_{obj}.

The device can be characterised in that the microprocessor also includes a tolerance-compensation module, for determining a corrected value T′_{obj} on the basis of the object temperature T_{obj} according to the formula:

T′obj=A T_{obj}+B.

A and B corresponding to gain-correction and zero-offset-correction terms stored in memory upon calibration of the thermopile assembly during manufacture.

According to one preferred embodiment, the device is characterised in that it includes:

a divider bridge for biasing one terminal of the thermopile assembly which is coupled to one terminal of a thermistor associated with the thermopile, the said terminal delivering the said second voltage U₂.

an operational amplifier for amplifying the voltage at the said terminals of the thermopile assembly and producing the said first voltage U₁ as output.

### BRIEF DESCRIPTION OF THE DRAWINGS

Other characteristics and advantages of the invention will emerge better on reading the description below, in connection with the attached drawings, in which:

FIG. 1 is a block diagram for implementation of the invention;

FIG. 2 represents a preferred embodiment of the invention;

FIG. 3 illustrates a mapping representing T_{obj} as a function of U₁ and U₂, FIG. 4 being an example of mapping of FIG. 3.

and FIG. 5 illustrates a gain compensation and zero-offset compensation for the temperature measurement.

### DESCRIPTION OF THE PREFERRED EMBODIMENTS

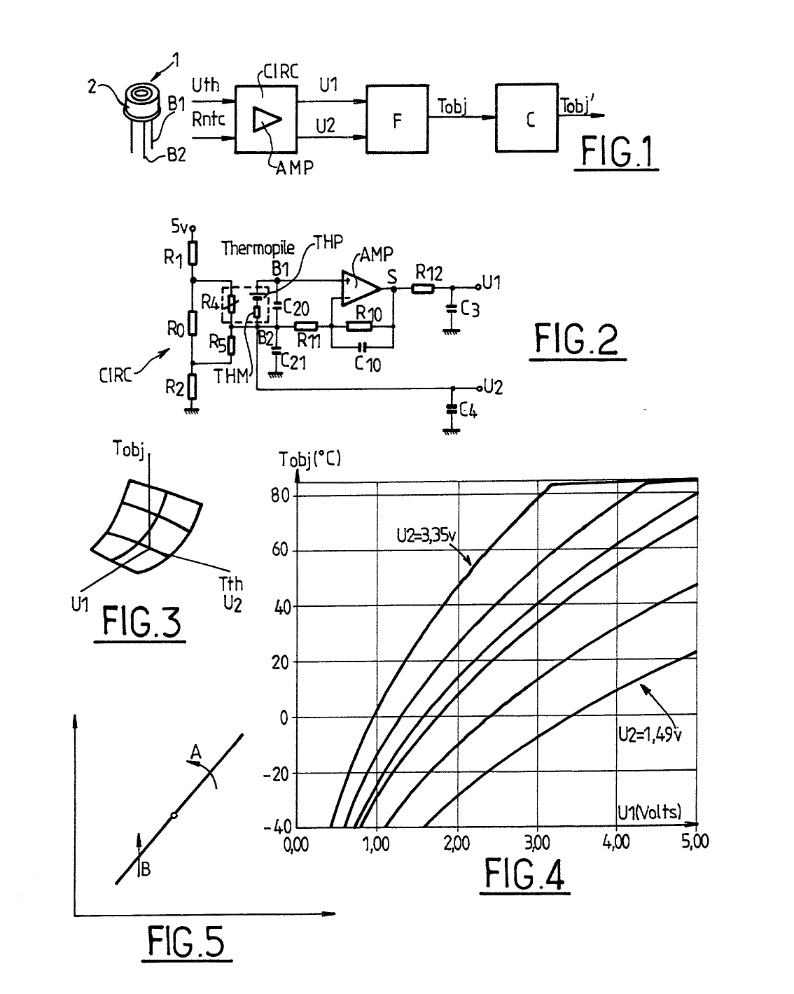

As illustrated in FIG. 1, a device according to the invention features a thermopile assembly 1 which supplies voltages Uₜₕ and R_{ntc} respectively at two live terminals B1 and B2. Within the housing 2 of the thermopile assembly 1 are mounted, in series, a component THP constituting a thermopile in the strict sense, one terminal of which is the terminal B1, and a thermistor THM, one terminal of which is the terminal B2 (FIG. 2). A circuit CIRC, featuring an operational amplifier AMP, supplies voltages U₁ and U₂ at its output, which are advantageously calibrated between 0V and 5V, and these voltages are applied to analog inputs of a microprocessor device F where they are digitised and processed so as to supply, as output, a digital signal representing the temperature T_{obj} to be measured, or else a corrected measured temperature T′_{obj} (after compensation in a calculation module C).

As FIG. 2 shows, the terminal B1 of the thermopile assembly 1 is connected to the non-inverting input of the amplifier AMP, the output S of which, filtered by a network (R₁₂, C₃) supplies a voltage U₁ (for example, R₁₂=10 k ; C3=10 nF). The terminal B2 of the thermopile assembly 1 is connected to one terminal of a resistor R₁₁, the other terminal of which is connected to the inverting input of the amplifier AMP. The resistor R₁₁ and a resistor R₁₀ define the gain G of the amplifier AMP (G=1000; R₁₀=267 k; R₁₁=267, for example). A capacitor C₁₀ (C₁₀=10 nF, for example) is connected to the terminals of the resistor R₁₀.

The capacitors C₂₀ and C₂₁ will also be noted, of substantially equal value (for example 10 nF), mounted in bridge layout between B1, B2 and earth.

The terminal B2 is fed from a voltage source V (for example V=5 V) through a double bridge featuring the resistors R₁, R₀ and R₂ (for example, R₁=R₂=511 and R₀=750), and the resistors R₄ and R₅ in parallel with R₀ (with R₄=R₅=10 k , for example), R4 being a variable resistor, particularly one integrated into the thermopile 1.

The operational amplifier AMP preferably features a zero offset of less than 10 V and common-mode rejection of greater than 130 dB. As for the resistors, items of 1% precision class are preferably used.

The voltage U1 available at the output S of the amplifier AMP, after any filtering by (R₁₂, C₃), is, to a first approximation, proportional to the temperature T_{obj} of the object to be measured and inversely proportional to the temperature Tₜₕ of the casing 2 of the thermopile 1.

As for the voltage U2, it is, to a first approximation, proportional to the temperature Tₜₕ of the housing 2 of the sensor 1 (this is due to the presence of the thermistor THM which is in thermal contact with the housing 2 of the sensor 1) giving Tₜₕ−K₄ U2.

A precise calculation can be carried out in the following way:

The voltage U1 represents thermal equilibrium between two physical phenomena:

a—Energy received originating from outside the sensor via the IR filter:

According to Planck's law:

$${U}_{1} = {\int }_{λ min}^{λ max} K1 \frac{{C}_{1} {λ}^{- 5}}{- 1 + e ( \frac{C2}{λ Tobj} )} g ( λ ) ⅆ λ$$

min and max are respectively the lower and upper bounds, in terms of wavelength, of the infrared filter IR,

g( ) is the response of the sensor between min and max,

C1 and C2 are the Planck constants,

K1 is a constant,

b—exchange by radiation with the outside world (loss by radiation, sensitivity optimum).

The energy is proportional to the difference between the temperature Tₜₕ of the housing 2 and the temperature T_{gr} of the thermopile element

i K₂(Tgr⁴−Tth⁴)

At equilibrium, the voltage delivered by the thermopile is equal to:

$${U}_{1} = \frac{{K}_{3}}{{T}_{th}^{3}} {\int }_{λ min}^{λ max} \frac{{C}_{1} {λ}^{- 5}}{- 1 + e ( \frac{{C}_{1}}{λ {T}_{obj}} )} ⅆ$$

K3 is a constant.

The temperature of the object Tobj is deduced by calculation from the foregoing formula.

The results can be stored in memory according to a two-dimensional mapping (see FIGS. 3 and 4), giving Tobj as a function of the voltage U1 and of the voltage U2 (or of Tₜₕ ), stored in memory in the form of a table of values, for example in a read-only memory or a flash memory. In FIG. 4, U1 is given as a function of Tobj for values of U2 varying between 1.49 V and 3.35 V.

It is also possible to take into account compensation for zero-offset and for gain in order to reduce the dispersion between the thermopile assemblies. To that end, gain-offset coefficients A and zero-offset coefficients B are stored in memory upon calibration of the thermopiles 1 during manufacture.

A therefore corresponds to a multiplication coefficient to be applied (see FIG. 5) to rediscover the nominal gain sought A₀. Thus a corrected temperature is deduced:

T′obj=A Tobj+B

What is claimed is:

1. Method of measurement employing thermal compensation of a thermopile assembly arranged in a sensor housing and including a thermopile and a thermistor, and employing:
a) the generation of a first thermopile voltage U₁ which is a function of an object temperature T_{obj} to be measured, and of a temperature Tₜₕ of the sensor housing, and of a second thermistor voltage U₂ which is proportional to the temperature Tₜₕ of the sensor housing.
b) the analog/digital conversion of the first voltage U₁ and of the second voltage U₂.
c) the calculation of the object temperature T_{obj} on the basis of the said digitised voltages U₁ and U₂, characterised in that T_{obj} is obtained from the following formula:
$${U}_{1} = \frac{{K}_{3}}{{T}_{th}^{3}} {\int }_{λ min}^{λ max} \frac{{C}_{1} {λ}^{- 5}}{exp ( {C}_{2} / λ Tobj ) - 1}$$
with:
K₃:constant
C₁, C₂:constants of Planck's law
:wavelength of the electromagnetic radiation
min, max: bounds of an infrared filter of the sensor.

2. Method according to claim 1, characterised in that T_{obj} is obtained from a table of values having values of T_{obj} corresponding to values of U₁ and U₂, according to a two-dimensional mapping.

3. Method according to claim 1, characterised in that it employs compensation for tolerances in order to determine a corrected value T′_{obj} from T_{obj}, according to the formula:
T′_{obj}=A T_{obj}+B
A and B corresponding to gain-correction and zero-shift-correction terms which are stored in memory upon calibration of the thermopile assembly during manufacture.

4. Device for implementing the method according to claim 1, characterised in that it includes:
an electronic circuit (CIRC) having inputs connected to two terminals of the thermopile assembly so as to supply a said first voltage U₁ and a said second voltage U₂ as output.
a microprocessor (F) storing in memory a relationship between the said first and second voltage U₁ and U₂ and the object temperature T_{obj}.

5. Device according to claim 4, characterised in that the microprocessor also includes a tolerance-compensation module (C) for determining a corrected value T′_{obj} on the basis of the object temperature T_{obj} according to the formula:
T′obj=A Tobj+B.
A and B corresponding to gain-correction and zero-offset-correction terms stored in memory upon calibration of the thermopile assembly during manufacture.

6. Device according to claim 4, characterised in that it includes:
a divider bridge for biasing one terminal (B₂) of the thermopile assembly which is coupled to one terminal of a thermistor (THM) associated with the thermopile (THP), the said terminal delivering the said second voltage U₂.
an operational amplifier (AMP) for amplifying the voltage at the said terminals (B₁, B₂) of the thermopile assembly (1) and producing the said first voltage U₁ as output.
